(19) United States
(12) Patent Application Publication
(10) Pub. No.: US 2011/0179061 A1
(43) Pub. Date: Jul. 21, 2011

(54) Extraction and Publication of Reusable Organizational Knowledge

(75) Inventors: Venkat Pradeep Chilakamarri, Redmond, WA (US); Nicholas Caldwell, Bellevue, WA (US); Saliha Azzam, Redmond, WA (US); Yizheng Cai, Sammamish, WA (US); Benjamin Edward Childs, Seattle, WA (US); Arun Chitrapu, Seattle, WA (US); Steven Dimmick, Mill Creek, WA (US); Michael Gamon, Seattle, WA (US); Bernhard SJ Kohlmeier, Woodinville, WA (US); Shiun-Zu Kuo, Bothell, WA (US); Jonathan C. Ludwig, Kirkland, WA (US); Kimberly Manis, Seattle, WA (US); Courtney Anne O'Keefe, Bellevue, WA (US); Diego Perez Del Carpio, Redmond, WA (US); Tu Huy Phan, Redmond, WA (US); Kevin Powell, Kirkland, WA (US); Jignesh Shah, Bellevue, WA (US); Ashish Sharma, Bellevue, WA (US); Paulus Willem ter Horst, Bothell, WA (US); Mukta Pramod Walvekar, Sammamish, WA (US); Ye-Yi Wang, Redmond, WA (US)

(73) Assignee: Microsoft Corporation, Redmond, WA (US)

(21) Appl. No.: 12/818,718

(22) Filed: Jun. 18, 2010

Related U.S. Application Data
(60) Provisional application No. 61/296,343, filed on Jan. 19, 2010.

(51) Int. Cl. G06F 17/30

(52) U.S. Cl. 707/769; 707/705; 707/E17.009; 707/E17.014

(57) ABSTRACT

An analysis module, when triggered by a synchronization framework when a new data item is added to a project data store, runs a series of analysis feature extractors on the new content. An analysis may be conducted, and features of interest may be extracted from the data item. The analysis utilizes natural language processing, as well as other technologies, to provide an automatic or semi-automatic extraction of information. The extracted features of interest are saved as metadata within the project data store, and are associated with the data item from which it was extracted. The analysis module may be utilized to discover additional information that may be gleaned from content that is already in the project data store.

### CROSS REFERENCE TO RELATED APPLICATIONS

This application claims benefit under 35 U.S.C. §119(e) of U.S. Provisional Patent application Ser. No. 61/296,343 entitled “Aggregating and Presenting Associated Information (Huddle)” and filed on Jan. 19, 2010, the entirety of which is incorporated by reference herein.

### BACKGROUND

Oftentimes in a work environment, content that may be pertinent and reusable to multiple users may be unavailable to others. Content may be contained within various electronic files, such as electronic documents, electronic mail, calendar items, contacts items, tasks items, instant messages, SMS test messages, social networking communications, or other content repositories to which others may not have access. Or while others may have access to needed content, the content may be stored where it may be difficult for others to find. Because content may not be available and shared among users, redundancies may be commonplace. For example, a user may be asked a question by a team member, wherein the user may provide an answer via email. Another team member may have the same or a related question, and may ask the user the same question. The user may have to retype the same response multiple times, which can be a waste of time and resources.

Content contained within various electronic files may not be easily found by an individual. For example, task or meeting information may be contained within an email to a user. Although the user may have access to the information, a specific piece of content (e.g., task or meeting information) may not be easily discovered, and may take extra time to find.

It is with respect to these and other considerations the present invention has been made.

### SUMMARY

Embodiments of the present invention solve the above and other problems by providing for automatically analyzing content contained in sources of unstructured data, discovering, and extracting interesting reusable data, and storing that data in a public repository where others may find it via a search, browsing, recommendations, etc.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1A is a block diagram of an operating environment of a project data aggregation and management (PDAM) application;

FIG. 1B is a block diagram of an operating environment for providing automatic extraction of reusable content.

FIG. 2 is an illustration of an example PDAM user interface showing extracted questions and answers.

FIG. 3 is an illustration of an example PDAM user interface showing extracted glossary items.

FIG. 4 is a flow chart of a method for providing automatic extraction and publication of reusable data; and

FIG. 5 is a block diagram of a system including a computing device.

### DETAILED DESCRIPTION

Embodiments of the present invention are directed to automatically analyzing and extracting reusable information from a variety of electronic files, such as electronic documents, electronic mail, calendar items, contacts items, tasks items, notes, text messages, social networking communications, conversations, or other content repositories to which others may not have access or which others may find difficult to locate. The analyzed and extracted information may be automatically published to a shared team repository.

The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

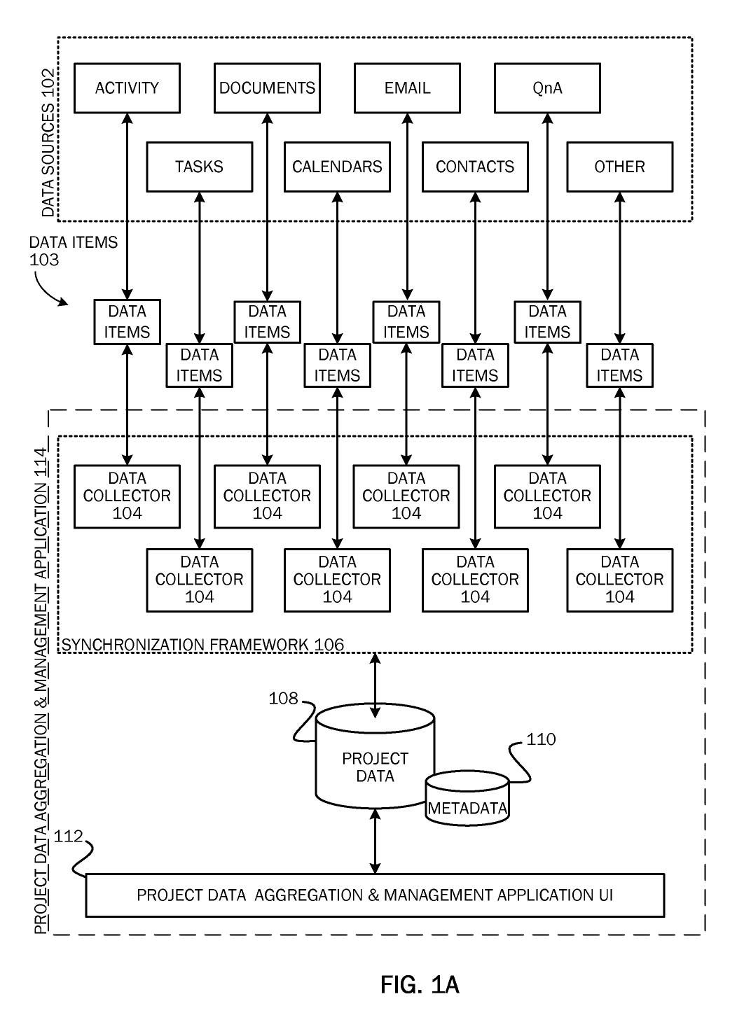

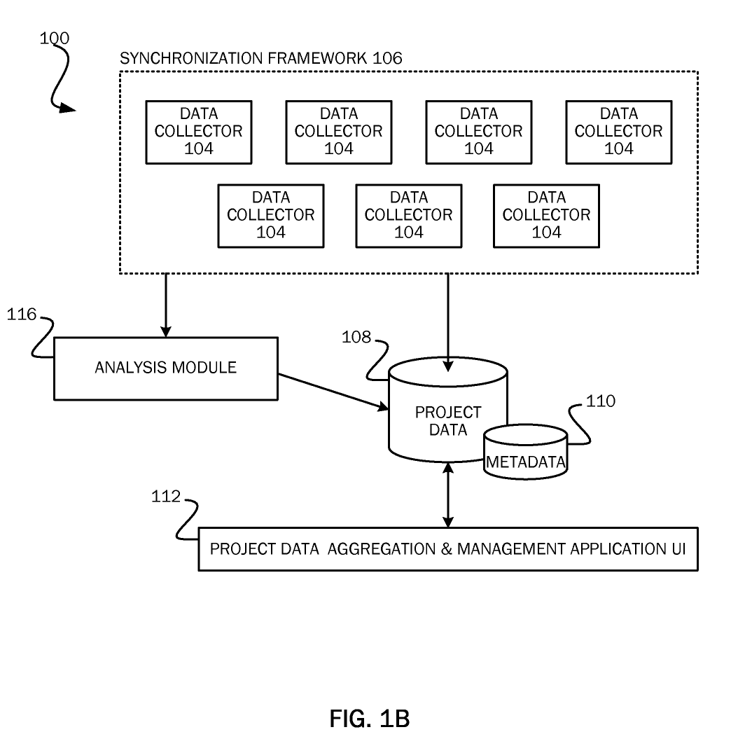

Referring now to the drawings, in which like numerals represent like elements through the several figures, aspects of the present invention and the exemplary operating environment will be described. FIGS. 1A and 1B and the following discussion are intended to provide a brief, general description of a suitable operating environment in which the invention may be implemented. While the invention will be described in the general context of program modules that execute in conjunction with an application program that runs on an operating system on a wired or mobile computing device, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

As briefly described above, embodiments are directed to automatically analyzing and extracting reusable information from a variety of electronic files, such as electronic documents, electronic mail, calendar items, contacts items, tasks items, notes, text messages, conversations, social networking communications, or other content repositories to which others may not have access or which others may find difficult to locate. In addition, context of analyzed and extracted data items is discovered, and sources of information that may be relevant to given data items is assembled. FIG. 1A illustrates a system framework of a project data aggregation and management application (PDAM application) 114 with which embodiments of the present invention may be implemented.

FIG. 1A is a simplified block diagram of a system architecture for embodiments of a PDAM application 114. Embodiments of PDAM application may be utilized as a project data aggregation and management tool. Referring now to FIG. 1A, data items 103 may be provided. Data items 103 may be of various content types, and may be from various data sources 102. Data sources 102 may include, but are not limited to, activities, documents, electronic mail, questions and answers, tasks, calendars, contacts, notes, text messages, conversations, social networking communications, or any other electronic data from which data relevant to a one or more projects may be retrieved. Data items 103 may be located within a local file system, within a web-based content management system, such as SHAREPOINT by MICROSOFT CORPORATION of Redmond, Wash., or located remotely and linked through a communications network. In a distributed computing environment, data items 103 may be located in both local and remote memory storage devices. A data item 103 may be, for example, a calendar item, a contact item, an electronic mail (“email”) communication, a social networking communication, a text message, an announcement, a task item, a note, an electronic document (e.g., word processing document, spreadsheet document, slide presentation document, etc.), photographic files, audio files, or any other item of data that may be relevant to one or more projects of interest. As used herein, the term “project” is not meant to be limited to an endeavor or undertaking to create a product or service, but may include any subject matter wherein two or more pieces of data or other information may be associated with the subject matter and aggregated for organization and management.

Embodiments of the present invention may comprise a synchronization framework 106, which is a framework of data collection interfaces 104, herein referred to as data collectors. A data collector 104 is an interface that may communicate with a data source 102, and extract data items 103 that may contain relevant information to a project from the data source 102. Data items 103 may be pulled from a data source 102, or alternatively, may be pushed form a data source to a data collector 104. A project may be created by a user within a PDAM application 114. When a project is created, a title and description may be given to the project, which may be used as metadata 110 for automatically discovering content that may be of relevance to the project. Data collectors 104 may search for content locally and from external repositories. Discovered content may be suggested to a user, wherein the user may accept a suggested piece of content and that data item 103 may be extracted and stored into a project data store 108.

Information that is exchanged between a data source 102 and a data collector 104 may be customizable. For example, if the data source 102 is an electronic mail application, electronic calendar application, electronic task application, or an application that provides combined resources of these applications, for example, OUTLOOK by MICROSOFT CORPORATION of Redmond, Wash., a data collector 104 may be implemented to interface the email application so that it may be operative for discovering data and metadata of an email. As should be appreciated, there may be multiple extraction points of a data source 102. Accordingly, there may be multiple data collectors 104 for a data source 102. Considering the above example, where the data source 102 is an electronic mail application, electronic calendar application, electronic task application, or combination functionality application, one data collector 104 may be implemented to discover email data, and another data collector 104 may be implemented to discover calendar data, and another to discover task data, etc. A data collector 104 may know not only where to get data, but also how and what type of data to retrieve.

As new data sources 102 are added to a project, a synchronization framework 106 may implement new data collector 104 interfaces. For every possible type of collection, an implementation of that interface may be added to the synchronization framework 106. The synchronization framework 106 may pull in data as well as push data back out to a data source 102. Data may be pulled in via one of two modes. According to a first mode, a data source 102 may be checked for new content according to a specified time interval. For example, a data source 102 may be checked every thirty (30) seconds to see if there is new data available. With some data sources 102, it may be inefficient to pull data in such a manner. By utilizing a subscriber-type model, a data source 102 may notify the synchronization framework 106 when a change occurs. Consider, for example, that a data collection, organization and sharing application, for example, SHAREPOINT by MICROSOFT CORPORATION is a data source 102 for a project. The application may use very large lists to transfer data. The list may have thousands of elements, so it would be inefficient to pull them and check a thousand elements every thirty (30) seconds for new data. Accordingly, a second mode may be utilized to check for new data. The synchronization framework 106 may register for an event, wherein the synchronization framework 106 may be notified when a change has occurred.

As data items 103 that are of relevance to a project are pulled from a data source 102 by a data collector, that data may be stored in a project data store 108. The project data store 108 is a data repository or organizational knowledge base, and may be available to and access by others. Data collectors 104 may put data into a project data store 108 in whatever way may be most efficient for the system. For example, if document information is being collected, that data may be put into the data store 108 by downloading the document and associating the whole document with the project. Alternatively, instead of downloading the full document, a link to the document may be downloaded; and, the link information may be tagged with a last modification date. In the same way that various forms of data may be collected from a variety of aggregation points, the way the data is stored internally can vary. Project data 108 may be a collection of identifications to actual data that may be stored locally or in disparate locations. Data may comprise project related content as well as contact information, and any other available content that may be relevant to a project. A project data store 108 may also comprise metadata 110, such as a title or keywords, description, other people who may be joined and working on a project, security descriptors, types of content that should be stored within a project, and how it should be displayed in a user interface 112.

According to one embodiment, data may be stored in a database table, for example a structured query language (SQL) data table. After a project data store 108 is created, all associated content may be added into the data store. The content may consist of a generic wrapper that provides a name, an identifier, a creation date, and other pieces of metadata along with payloads, which consist of the actual data or links to the actual data. For example, if a user adds a contact to a project, a wrapper may be created that may contain a title of the contact, a date it was created, etc., and a payload. For a contact, the payload would be the unique identifier of the user who is being added as a contact. For every type of content within a project, a wrapper and payload exists.

According to an embodiment, a project may coexist with enterprise-level structured projects which may be projects associated with data, data sources and projects spanning organizations and entities of varying sizes and structures. An enterprise project may be a source from which information may be extracted. An enterprise project may comprise deliverables, which may be defined as PDAM application projects. An overall project system may manage these deliverables or PDAM application projects.

A PDAM application user interface (UI) 112 is a modular user interface that may display data items 103 from multiple data sources 102. For example, a PDAM application UI 112 may display data items 103 like calendar data, emails, tasks, etc. as well as any other type of data, such as word processing documents, spreadsheet documents, presentation documents, notes documents, and social networking correspondences. The PDAM application UI 112 may borrow functionality of one or more applications, such as an electronic mail application, electronic calendar application, electronic task application, or an application that provides combined resources of these applications for displaying and interacting with calendar, task and email items. The PDAM application UI 112 may also extend functionalities of other applications so that it may display other relevant project information.

Within a PDAM application UI 112, a notification system may be provided. According to an embodiment, when a data collector 104 retrieves a data item 103 from a data source 102, a user may be notified through the PDAM application UI 112 that new information is available, so that the user may then act on it. For example, a person in a project may upload a new document relative to the project. Other members in the project may need to know that a new document has been uploaded. The other users may receive a notification that a new activity is available. According to an embodiment, a notification may be provided depending on a data source 102 type. For example, an email routed to a project for a given user may not require a notification to other users of the project.

According to another embodiment, a user may publish new data through the PDAM application UI 112 that can be sent out to various data sources 102. For example, if a user has a project linked to various communication sources, such as email, instant messaging, and one or more social networks, for example, FACEBOOK or TWITTER, the user may push content back out to one or more of those communication sources. The user may create an email or text message or other suitable messaging form from within the PDAM application UI 112. The PDAM application UI 112 may act as an aggregator of content as well as a way to push content back out to any desired recipient user or recipient system.

Having described a system framework of a project application and management application (PDAM application) 114, with which embodiments of the present invention may be implemented, FIG. 1B is a simplified block diagram of an operating environment 100 for providing an automatic analysis and extraction of reusable information from a variety of various electronic files, such as electronic documents, electronic mail, calendar items, contacts items, tasks items, notes, text messages, social network communications and the like and an automatic publication of the extracted reusable organizational information to a shared team repository. As should be appreciated, some types of information may not be shared. For example, a data item that is directed to a given user (e.g., an extracted task, an email, etc.) may only be visible to that user. Referring now to FIG. 1B, a synchronization framework 106 is shown, wherein a framework, as was described above, is a collection of data collectors 104 that communicate with any data source, regardless of its type. The synchronization framework 106 may pull in data from various data sources, and store that data and its metadata 110 into a project data store 108.

An analysis module 116, also referred to as an analyzer, may be triggered by the synchronization framework 106 when new data items and content are added to the project data store 108. The analysis module 116 may run a series of analysis feature extractors on the new content, wherein an analysis may be conducted, and features of interest may be extracted from the data items. One or more features of interest extracted from the data items may include a keywords, questions, answers, terms, links, images, authors, senders, receivers, dates, names, times, as well as, other content from electronic documents, electronic mail, calendar items, contacts items, tasks items, social network communications, announcements, and the like. The analysis may utilize natural language processing to provide an automatic or semi-automatic extraction of information. The analysis may utilize other technologies, such as search and machine learning technologies, to extract information depending on a content type. The extracted features of interest may be saved as metadata 110 within the project data store 108, and may be associated with the data item from which it was extracted. Extracted features of interest may be associated with a plurality of data items 103. For example, a feature of interest may be extracted from a summary of an email thread, wherein the extracted results may be associated with the whole email thread and therefore associated with a set of data items 103 as opposed to a single data item. According to an embodiment, an analysis module 116 may be utilized to discover additional information that may be gleaned from content that is already in a project data store 108. As one example, metadata 110 associated with a given contact or user may be utilized to discover other projects to which he/she may subscribe. As new content is added and analyzed, and as new features of interest are extracted are saved as metadata 110 and added to the data store 108, old content may be reanalyzed for those new features of interest. The analysis module 116 may also reanalyze old content, such as electronic mail (email) threads. For example, if a new email on a conversation thread is added to the data store 108, the entire conversation thread may be reanalyzed, not just the new email.

As described above, features of interest which the analysis module 116 may extract may include a variety of aspects or components of a given data item. As one example, data within an address field and a subject field of an email may be extracted as metadata 110, as well as keywords within the body of the email. According to an embodiment, implicit information contained within data may be extracted by the analysis module 116. For example, within the body of an email, various tasks and questions may be interspersed throughout. None of the tasks or questions may be explicitly marked as tasks or questions. According to embodiments, the analysis module 116 is operative to extract the implicit tasks and questions from the content. Similarly, replies to the email may contain answers to the questions. Those answers may be extracted, paired with corresponding questions, and saved as metadata 110 within the project data store 108. According to an embodiment, features of interest may be aggregated into a separate repository. For example, questions and answers may be aggregated and stored into a separate database of frequently asked question (FAQ).

The analysis module 116 may also utilize the project data store 108 to store data associated with a user's interaction with suggested and/or stored metadata 110. This observed interaction and collected data may be utilized for learning functionalities so that future analyses may be improved. Project data may be displayed in a user interface 112, wherein a user may interact with project data. Data may be marked as private, public, or public to select users. For example, if data is extracted from a user's email, that data may be stored in a project data store 108, but may be private, and only accessible to that user. If a user chooses, he/she may specify that the data may be made public or accessible to others. While the analysis module 116 is shown as a separate module from the synchronization framework 106 in FIG. 1B, it should be appreciated that the analysis module 116 and the synchronization framework may operate as a single module.

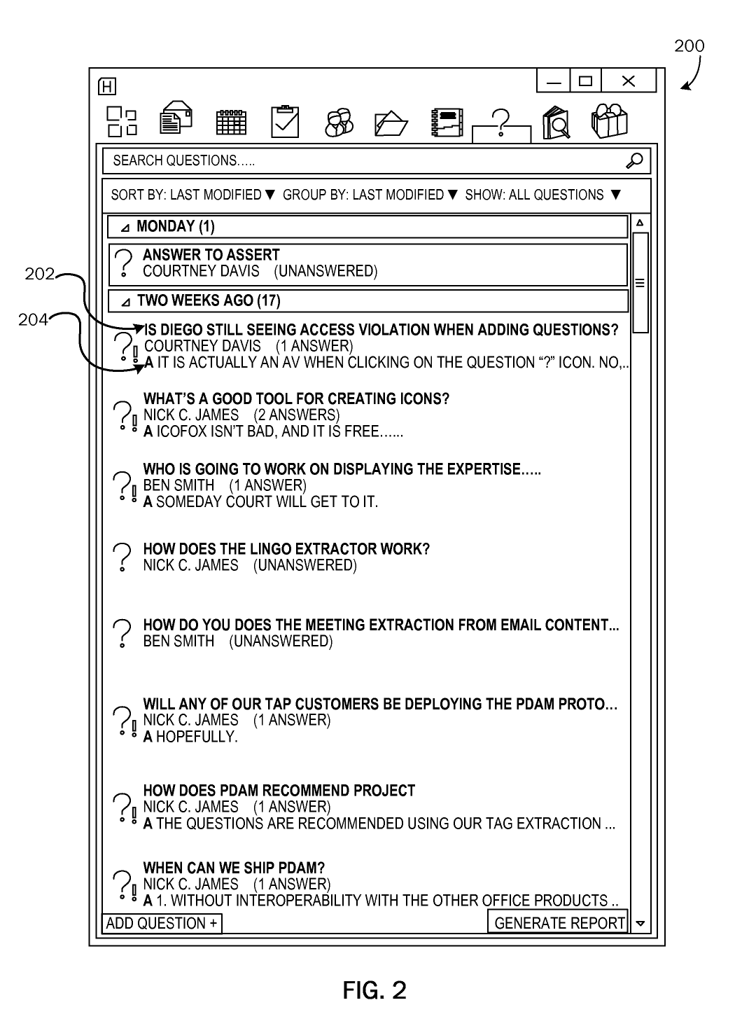

Referring now to FIG. 2, an illustration of an example PDAM application user interface (UI) 112 is shown. In this example UI 112, a question and answer (QnA) panel 200 is shown. A QnA panel 200 may be a shared project-specific repository of questions 202 and, if provided, answers 204 to the questions. As was described with reference to FIG. 1B, data, such as questions 202 and answers 204, may be extracted from a data item 103, such as an email or document, etc. As shown in FIG. 2, various questions 202 have been extracted from various data items 103. Question and answer items 202, 204 may not be explicitly marked as questions and/or answers in a data item 103, but may be automatically extracted from project data via an analysis module 116. Questions and/or answers may be added to a QnA panel upon approval by a user or by a direct post into the QnA panel. QnA items 202, 204 may be made public, and may be exposed to other members.

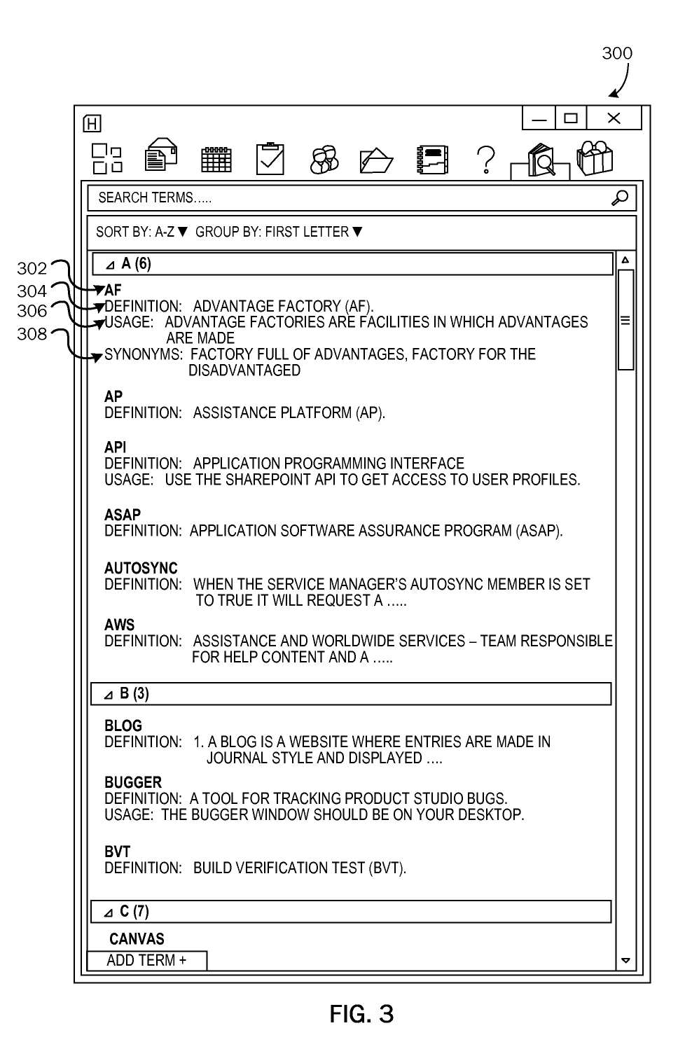

Referring now to FIG. 3, an example UI 112 showing a lingo panel 300 is illustrated. A lingo panel 300 may be a shared project-specific glossary of terms. Like the QnA panel 200 in FIG. 2, glossary items 302 may be automatically extracted from a variety of electronic files, such as electronic documents, electronic mail, calendar items, contacts items, tasks items, notes, social networking communications, conversations, text messages, and the like via an analysis module 116. As shown in FIG. 3, a definition 304, usage 306, and synonym data 308 may also be extracted from project data and provided in a UI 112.

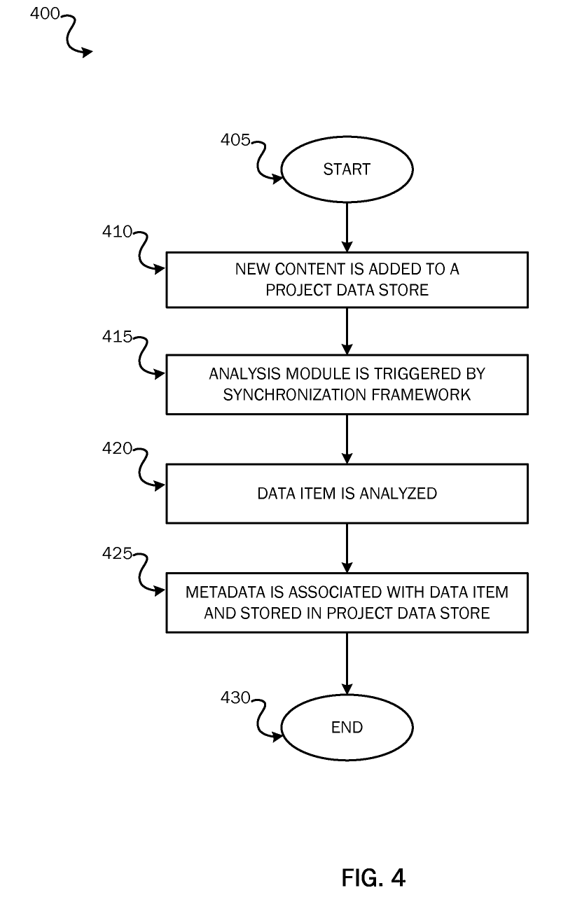

Referring now to FIG. 4, a process flow diagram of a method 400 for providing an automatic analysis and extraction of reusable organizational information from electronic files, such as electronic documents, electronic mail, calendar items, contacts items, tasks items, notes, text messages, conversations, social networking communications, or other electronic content, and an automatic publication of the extracted reusable information to a shared team repository will be described. According to one embodiment the method 400 comprises a method for providing extraction of a feature of interest from an unstructured data item, and population of the feature of interest into a structured data store. The method starts at OPERATION 405, and proceeds to OPERATION 410, where a data item 103 is added to a project data store 108. A data item 103 may comprise project related data and any other available content, such as content from electronic files, for example, electronic documents, electronic mail, calendar items, contacts items, tasks items, notes, text messages, social networking communications, and the like that may be relevant to a project. As described above, a data item 103 may be collected from a variety of data sources 102, including local and remote databases, servers, and web-based content management systems. A data item 103 may be added to a project data store 108 manually by a user, or automatically via a data collector interface 104.

The method 400 proceeds to OPERATION 415, where a synchronization framework 106 triggers an analysis module 116 to analyze new data items added to a project data store 108. At OPERATION 420, a data item 103 may be analyzed by the analysis module 116 for features of interest. The new data item(s) may be analyzed for one or more features of interest regardless of data type. A feature of interest may include, but is not limited to, a keyword, a question, an answer, a term, a link, an image, an author, a sender, a receiver, a portion of text, a date, a like topic/subject analysis, a contact suggestion. As should be appreciated, this list of features of interest is not meant to be an exhaustive list. The analysis module 116 may utilize natural language interpretation to find features of interest, wherein features of interest may be data that gives a context to a piece of content. For example, an email conversation may be occurring between two or more users. In one email, a user may ask a question about how a patent is filed. In a response to the email, another user may answer the question by stating that the process involves filing a patent application. He/she may also set up a meeting for discussing filing a patent. According to embodiments, the analysis module 116 may analyze the email string and extract the question, the answer, pair the question and answer, and extract the meeting information.

At OPERATION 425, extracted data may be stored as metadata 110 in a data store 108. The data store is a shared and searchable data repository. Metadata 110 may be associated with one or more other data items for which metadata or other information is also stored, and the stored metadata 110 may be discovered (and thus the data item may be discovered) through a search of the one or more other data items. According to an embodiment, a response from a user may be requested or required to save a piece of data as metadata 110. If the user accepts, the metadata 110 may be stored in the project data store 108. A user's interaction with suggested and/or stored metadata 110 may be observed and collected as data for utilization in a learning functionality. The method ends at OPERATION 430.

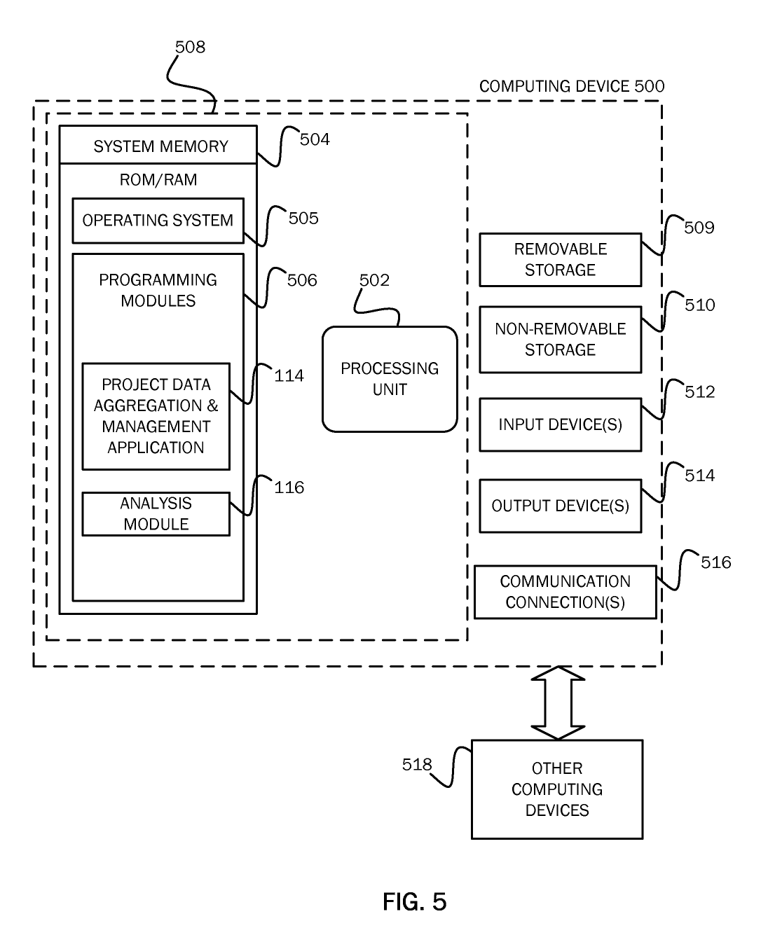

As described above, embodiments of the invention may be implemented via local and remote computing and data storage systems, including the systems illustrated and described with reference to FIGS. 1 and 2. Consistent with embodiments of the invention, the aforementioned memory storage and processing systems may be implemented in one or more computing devices, such as computing device 500 illustrated in FIG. 5. Any suitable combination of hardware, software, or firmware may be used to implement the memory storage and processing unit. For example, the memory storage and processing unit may be implemented with computing device 500 or any other computing devices 518, in combination with computing device 500, wherein functionality may be brought together over a network in a distributed computing environment, for example, an intranet or the Internet, to perform the functions as described herein. The aforementioned system, device, and processors are examples and other systems, devices, and processors may comprise the aforementioned memory storage and processing unit, consistent with embodiments of the invention. Furthermore, computing device 500 may comprise operating environment 100 as described above. Operating environment 100 is not limited to computing device 500.

With reference to FIG. 5, a system consistent with embodiments of the invention may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include project data aggregation and management application 114 and analysis module 116, wherein project data aggregation and management application 114 and analysis module 116 are software applications having sufficient computer-executable instructions, which when executed, performs functionalities as described herein. Operating system 505, for example, may be suitable for controlling computing device 500's operation. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computing device 500 may also contain a communication connection 516 that may allow device 500 to communicate with other computing devices 518, such as over a network in a distributed computing environment, for example, an intranet or the Internet. Communication connection 516 is one example of communication media.

As described above, a number of program modules and data files may be stored in system memory 504, including operating system 505. While executing on processing unit 502, programming modules 506 (e.g. project data aggregation and management application 114) may perform processes including, for example, one or more of method 200's stages as described above. The aforementioned process is an example, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, or transport the program for use by or in connection with the instruction execution system, apparatus, or device.

The term computer readable media as used herein may include computer storage media. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing extraction of a feature of interest from a data item, and population of the feature of interest into a data store, the method comprising:
receiving an indication of a new data item added to a data store;
analyzing the new data item for one or more features of interest;
extracting one or more features of interest from the new data item; and
storing the extracted features of interest as metadata associated with the new data item in the data store.

2. The method of claim 1, wherein the one or more features of interest includes a keyword, a question, an answer, a term, a link, an image, an author, a sender, a receiver, a name, a portion of text, or a date.

3. The method of claim 1, wherein analyzing the new data item for one or more features of interest includes analyzing the new data item for one or more features of interest via a natural language interpretation of the new data item.

4. The method of claim 1, wherein receiving an indication of a new data item added to a data store includes receiving the indication of a new data item added to a data store via a synchronization framework.

5. The method of claim 1, wherein a data item is one of electronic documents, electronic mail, calendar items, contacts items, tasks items, notes, text messages, conversations, and social networking communications.

6. The method of claim 1, wherein the new data item is analyzed for one or more features of interest regardless of its data type.

7. The method of claim 1, wherein the data store is a shared and searchable data repository.

8. The method of claim 1, further comprising associating the metadata associated with the new data item with one or more other data items, wherein the stored metadata is discoverable through a search of the one or more other data items.

9. A computer-readable medium which stores a set of instructions which when executed performs a method for providing extraction of a feature of interest from an unstructured data item, and population of the feature of interest into a structured data store, the method executed by the set of instructions comprising:
receiving an indication of a new data item added to a data store via a synchronization framework;
analyzing the new data item for one or more features of interest;
analyzing previously stored data items for one or more features of interest;
extracting one or more features of interest from the new data item;
suggesting the one or more extracted features of interest;
in response to an acceptance of the suggested one or more extracted features of interest, storing the extracted features of interest as metadata associated with the new data item in the data store; and
utilizing data associated with an acceptance or declination of one or more suggested extracted features of interest for learning functionalities for future analyses.

10. The computer-readable medium of claim 9, wherein analyzing the new data item for one or more features of interest includes analyzing the new data item for one or more features of interest via a natural language interpretation of the new data item.

11. The computer-readable medium of claim 10, wherein a data item is one of electronic documents, electronic mail, calendar items, contacts items, tasks items, notes, text messages, conversations, and social networking communications.

12. The computer-readable medium of claim 10, wherein one or more features of interest includes a keyword, a question, an answer, a term, a link, an image, an author, a sender, a receiver, a name, a portion of text, or a date.

13. The computer-readable medium of claim 9, wherein receiving an indication of a new data item added to a data store via a synchronization framework includes receiving the indication of the new data item added to the data store via a data collector included in the synchronization framework.

14. The computer-readable medium of claim 9, wherein the new data item is analyzed for one or more features of interest regardless of its data type.

15. The computer-readable medium of claim 9, wherein the data store is a shared and searchable data repository.

16. The computer-readable medium of claim 9, further comprising associating the metadata associated with the new data item with one or more other data items, wherein the stored metadata is discoverable through a search of the one or more other data items.

17. A system for providing extraction of a feature of interest from an unstructured data item, and population of the feature of interest into a structured data store, the system comprising:
a memory storage;
a processing unit coupled to the memory storage;
an analysis module operative to:
receive an indication of a new data item added to a data store;
analyze the new data item for one or more features of interest;
extract one or more features of interest from the new data item; and
store the extracted features of interest as metadata associated with the new data item in the data store.

18. The system of claim 17, further comprising a synchronization framework operative to receive the indication of the new data item added to a data store.

19. The system of claim 17, wherein the analysis module is further operative to utilize natural language interpretation to analyze various types of data items for one or more features of interest.

20. The system of claim 17, wherein the data store is a shared and searchable repository.
